(19) United States
(12) Patent Application Publication
(10) Pub. No.: US 2019/0355200 A1
(43) Pub. Date: Nov. 21, 2019

(54) DEVICE AND METHOD FOR SUPPORTING THE VERIFICATION OF A SECURITY DOCUMENT BY MEANS OF A TOUCHSCREEN

(71) Applicant: ORELL FÜSSLI SICHERHEITSDRUCK AG, Zürich (CH)

(72) Inventors: Sylvain CHOSSON, Zürich (CH); Martin EICHENBERGER, Zollikon (CH)

(73) Assignee: ORELL FÜSSLI SICHERHEITSDRUCK AG, Zürich (CH)

(21) Appl. No.: 16/473,652

(22) PCT Filed: Dec. 29, 2016
(86) PCT No.: PCT/CH2016/000159

§ 371 Date: Jun. 26, 2019

(51) Int. Cl. G07D 7/128; G06F 3/044; G06F 3/14; G07D 7/1205; G07D 7/207; G06K 7/10

(52) U.S. Cl. CPC G07D 7/128; G06F 3/044; G06F 3/14; G06F 3/16; G07D 7/207; G06K 7/10366; G07D 7/1205

(57) ABSTRACT

In order to support the verification of a security document, the document is placed on a verification device having a touchscreen. A conductive structure embedded in the document is detected by the touchscreen and the position and orientation of a window in the document is calculated therefrom. The verification device then displays an image positioned and rotated to appear at the location of the window. The image may interact with the document to generate Moiré patterns, fluorescent images or animations.

### TECHNICAL FIELD

The invention relates to a method and device for supporting the verification of a security document.

### BACKGROUND ART

Various methods and devices for supporting the verification of a security documents are known. For example, short-wavelength lamps can be used for exciting fluorescent inks on the security document, or detectors can be provided for detecting non-visible features such as magnetic or infrared-absorbing inks.

The ongoing fight against new methods of counterfeiting provides a constant need for new methods and devices that support the verification of security documents.

### DISCLOSURE OF THE INVENTION

Hence, the problem to be solved is to provide a method and device of the type mentioned above that can be used in the verification of a security document.

This problem is solved by the independent claims.

Accordingly, a method for supporting the verification of a security document is provided, which e.g. helps a human user or a machine to establish that a given document is valid. This method is adapted to verify a security document that comprises at least one electrically conductive structure, and it comprises at least the following steps:

Detecting, by means of a touchscreen of a verification device, the presence, position and orientation of said conductive structure on said touchscreen. In other words, the touchscreen's sensors are used for detecting the conductive structure of the document, but not only its presence, but also its position (location) as well as orientation (rotation).

Displaying, on said touchscreen, at least one image whose position and/or orientation depends on the position and orientation of said conductive structure. Hence, an image (which can e.g. comprise graphical objects and/or text) is displayed on the touchscreen. The position and/or the orientation of this image depend on the position and the orientation of the security document.

These steps can be used to make the verification process easier.

Advantageously, both said position and orientation of the image depend on the position and the orientation of the security document, i.e. the image is rotated and positioned as a function of the position and the orientation of the security document.

In a particularly advantageous embodiment, the security document comprises an “interaction region”. This interaction region may coincide with the whole document, but advantageously it is a true subregion of the document. The interaction region can e.g. be a window in the document, a region containing fluorescent ink or any ether region capable to produce an effect in combination with the image displayed by the touchscreen. The method comprises the following steps:

Calculating, from the position and orientation of said conductive structure, the position and orientation of said interaction region. In other words, the measured position and orientation of the conductive structure is used to calculate where, on the touchscreen, the interaction region of the security document is located.

Adjusting the position and orientation of at least a first region of said image to be located in said interaction region. Hence, this first region (which can correspond to part of the image or the complete image) is displayed right under the interaction region of the document. This allows the first region of the image to interact with the interaction region of the document.

Advantageously, this interaction region can be a window arranged in the document. In this context, a window is understood to be a region that is optically translucent to allow the passage of at least 40%, in particular of at least 80%, of light of at least one wavelength in the visible wavelength range, i.e. in a wavelength range between 390-700 nm. The window can e.g. be formed by an opening extending through the document or by a clear region of the document's substrate. It may carry small opaque structures.

The interaction region can carry a first repetitive pattern and the first region of said image can carry a second repetitive pattern, wherein said first and said second repetitive patterns have substantially equal spatial frequency. In this context, two patterns have “substantially equal spatial frequency” if the local periodicities of the two patterns differ by no more than 10%, such that distinct optical Moiré-type effects become visible.

In yet another embodiment, the interaction region comprises a fluorescent material, in particular a fluorescent ink. The fluorescent material advantageously reacts with blue wavelength light from the touchscreen. The light emitted by the touchscreen in said first region of the image has a spectrum selected to generate fluorescence in the fluorescent material. Thus, the fluorescence can be used during the verification process.

The conductive structure advantageously extends around at least half of the interaction region. This allows to determine the position and orientation of the interaction region more accurately.

Advantageously, the method can comprise the following steps:

Providing an original picture: This picture may e.g. be a photograph, such as the face of the document's bearer if the documentation is an identification document, but it may also e.g. be line art.

Applying a first part of said original picture to said document.

Displaying at least a second part of said picture as at least part of said image on said touchscreen in such an orientation and position that the first and second parts of the picture combine to re-create a larger part of said original picture than said first part only.

In this manner, the touchscreen can expand the first part of the image as printed on the document, which is an effect that can easily be verified.

In a particularly advantageous application of the invention, the document is an identification document and the picture is a photograph of the face of its bearer.

In another advantageous embodiment, the image displayed on the touchscreen can be animated.

For example, the image can animated at least when the document is at rest against the touchscreen. In this case, the image moves while the document stands still, which gives rise to an easily detectable effect.

In another example, the image can be animated to follow said document when said document is moved in respect to said touchscreen. This allows the image to retain its proper orientation and/or location even if the user moves the document along the touchscreen.

Advantageously, the method can comprise the following steps:

Detecting, by means of the touchscreen, a finger gesture indicative of (i.e. as caused by) a user touching the document while the document is placed against said touch screen.

Determining, from the position and orientation of the conductive structure as well as from the location of the finger gesture, a touched part of the document touched by the user. The “touched part” is that part (of several possible such parts) that the user has touched with his figure gesture.

Choosing the image or an animation displayed on said touchscreen. Choosing a sound or a sentence to be played by said verification device, e.g. the device could play an audio description of the document such as the banknote denomination value for visually impaired as a function of the touched part. The language of the audio description could be by default the one chosen by the user for his smartphone or tablet's operating system. In other word, depending on where the user touches the document, a different image can be shown.

The invention also relates to a verification device comprising a control unit and a touchscreen. This verification device is adapted and structured (by means of its hard- and software) to carry out the method as described above, with the potential exceptions of said steps of providing an original picture and applying a first part of said original picture to said document, which are typically steps that take place outside the verification device.

### BRIEF DESCRIPTION OF THE DRAWINGS

The invention will be better understood and objects other than those set forth above will become apparent when consideration is given to the following detailed description thereof. This description makes reference to the annexed drawings, which show:

FIG. 1 a device for verification, and/or education,

FIG. 2 a first security document,

FIG. 3 an image to be displayed by the verification device,

FIG. 4a the security document and the verification device in a first mutual orientation,

FIG. 4b the security document and the verification device in a second mutual orientation,

FIG. 4c the image displayed by the verification device in the first mutual orientation,

FIG. 4d the image displayed by the verification device in the second mutual orientation,

FIG. 5a a second security document,

FIG. 5b an image to be displayed by the verification device for the second security document,

FIG. 5c the second security document on the verification device, with the image of FIG. 5b displayed accordingly

FIG. 6a a third security document,

FIG. 6b an image or animation to be displayed by the verification device far the third security document,

FIG. 6c the third security document on the verification device, with the image or animation of FIG. 6b displayed accordingly,

FIG. 7a a picture,

FIG. 7b a fourth security document with a first part of the picture printed thereon,

FIG. 7c the fourth security document on the verification document in a first mutual orientation,

FIG. 7d the fourth security document on the verification document in a second mutual orientation,

FIG. 8a a fifth security document,

FIG. 8b an image to be displayed by the verification device for the fifth security document,

FIG. 8c the fifth security document on the verification device,

FIG. 9a a sixth security document,

FIG. 9b the sixth security document on the verification device, with the touchscreen displaying a specific wavelength to interact with document 9a, and

FIG. 10 a security document on a verification device with user-evocable images, animation, vibration, sound or flash effect.

### MODES FOR CARRYING OUT THE INVENTION

Introduction:

The present invention relates to a method and a verification device for supporting the verification of a security document. In this context, the term verification relates to the check of the authenticity of a security device. The described method and device support such a verification, i.e. they do not necessarily implement the verification step as well (even though they may), but often the step of recognizing if the document is genuine will be carried out by a user or, possibly, by an apparatus.

A first embodiment of a verification device and a security document are shown in FIGS. 1-3.

The Verification Device:

The verification device 1 of FIG. 1 is e.g. advantageously a smartphone or tablet computer, even though it can also be a dedicated piece of hardware. It comprises a touchscreen 2. As it is known to the skilled person, touchscreen 2 combines a display with a spatially resolving touch sensor. The touch sensor is able to recognize the locations of one or more fingers touching it. The position of the finger(s) can be resolved spatially, e.g. with a resolution better than +/−5 mm in two dimensions.

The touch sensor of touchscreen 2 is advantageously a capacitive touch sensor, e.g. one having a first set of parallel electrodes and a second set of parallel electrodes, with the first and second sets extending transversally to each other. By querying the capacitance between the electrodes of the first and second sets, the position of a finger resting against touchscreen 2 can be evaluated.

Verification device 1 is further equipped with a CPU capable to pet form calculations under program control as known to the skilled person.

The Security Document:

The security document is advantageously a banknote, a document of identification (such as a passport or an ID card), a credit card, a voucher, or any document of special value that should be protected against counterfeiting.

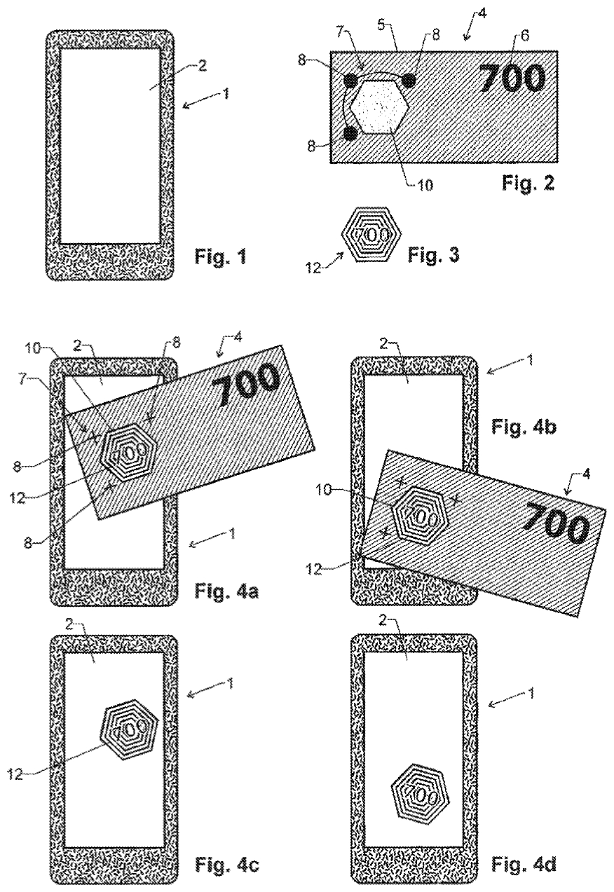

A banknote as an embodiment of such a security document 4 is shown in FIG. 2. It comprises a substrate 5, which can e.g. be of a polymer or paper (including cotton paper), or any combination thereof. It carries various insignia 6 and other elements printed thereon or applied thereto.

Further, security document 4 comprises an electrically conductive structure 7. Advantageously, conductive structure 7 is a metal structure. It can e.g. be implemented by printing conductive ink on substrate 1, e.g. on an outer surface or between laminate layers thereof. It can be visible or invisible to the user.

Conductive structure 7 can also be a conductive foam such as the one used at the rear end of pens adapted for touchscreen manipulation. Such a foam can e.g. be applied to the document by means of an intaglio process.

Advantageously, conductive structure 7 comprises at least one, advantageously several conductive regions 8 having diameters comparable to fingertips, e.g. between 0.3 and 1.5 cm. In the embodiment of FIG. 2, these regions are circular, even though other shapes can be used as well. (In the subsequent figures the conductive regions 8 are denoted by simple crosses.)

The conductive regions 8 are advantageously interconnected by electrical leads 9, with the electrical leads 9 thinner than the conductive regions 8.

When security document 4 is placed against touchscreen 2 of verification device 1, the touch sensor is able to evaluate the position and orientation of conductive structure 7, in particular the positions of the conductive regions 8. Once that verification device 1 has detected the positions of the conductive regions 8, it can calculate the orientation as well as position and also the side (front/reverse) of the whole security document 4.

The configuration of conductive structure 7, e.g. the number and mutual positions of the conductive regions 8, can be used to encode information. For a banknote, this information can e.g. be descriptive of the denomination and/or issuing country of a banknote.

Security document 4 further comprises, in the embodiment of FIG. 2, a window 10. Window 10 can e.g. be formed by a transparent polymer region of security document 4.

### First Embodiment

FIGS. 3 and 4a-4d illustrate a first embodiment of the invention to be used in combination with the security document of FIG. 2.

In this first embodiment, verification device 1 checks for the presence of security document 4 thereon by continuously scanning for the presence of a touch pattern corresponding to conductive structure 7.

If verification device 1 is adapted to cooperate with several types of security documents, the various types of documents can be equipped with differently configured conductive structures 7, and verification device 1 can be adapted to distinguish the types by analyzing the conductive structures 7.

Once that verification device 1 has detected the presence of security document 4 thereon, it will calculate its position, side and orientation as a function of the position and orientation of the detected conductive structure 7.

Then, verification device 1 will display an image on its touchscreen 2. The position and/or orientation of this image will depend on the position and orientation of security document 4.

In the first embodiment, the image 12 to be displayed on touchscreen 2 is shown in FIG. 3. It comprises a number indicative of the denomination of the security document as well as a graphical element shaped to match the contour of window 10.

The position and orientation of the image 12 to be displayed on touchscreen 2 depends on the position and orientation of conductive structure 7. It is chosen such that image 12 will automatically appear in window 10.

In more general terms, window 10 can be designated as the document's “interaction region”. The CPU of device 1 is programmed to calculate the position and orientation of the interaction region from the position and orientation of conductive structure 7, and then it adjusts the position and orientation of image 12 (or of at least of a part thereof) to appear in the interaction region.

This is illustrated in FIGS. 4a-4d, where FIGS. 4a and 4b show security document 4 in two different positions and orientations in respect to verification device 1, together with image 12 as displayed on touchscreen 2. FIGS. 4c and 4d correspond to FIGS. 4a and 4b, but with the security document not shown, which allows to see where image 12 is displayed on touchscreen 2 for the two cases of FIGS. 4a, 4b.

When the user moves the document between the positions shown in FIGS. 4a and 4b while it is in contact with touchscreen 2, verification device 1 can animate image 12 to follow window 10.

### Second Embodiment

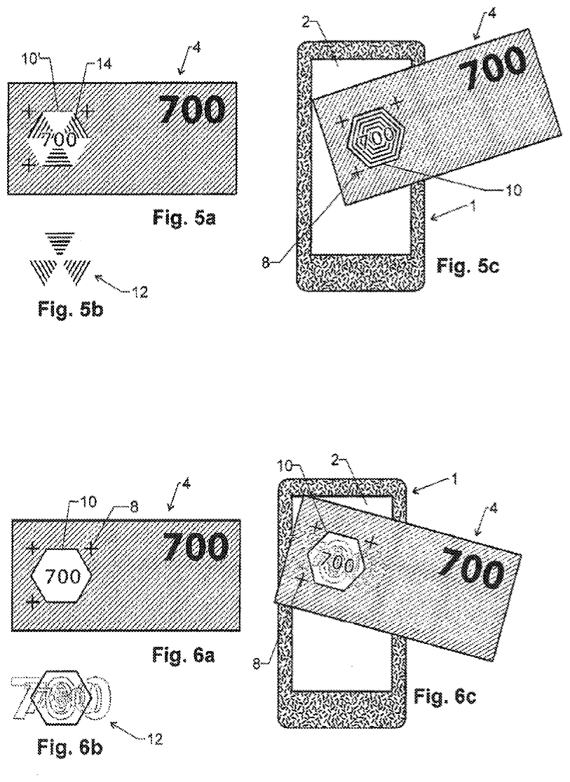

A second embodiment is shown in FIGS. 5a, 5b, 5c. In this embodiment, window 10 of security document 4 carries a pattern 14, which consists of a first part of the image shown in FIG. 3, i.e. half of the lines as well as the denomination.

The image 12 to be displayed by verification device 1 at the location of window 10 is shown in FIG. 5b. It consists of the second part of the image shown in FIG. 3, i.e. it consists of the other half of the lines.

When security document 4 is placed on verification device 1, the verification device will calculate the position and orientation of window 10 and then display image 12 therein, such that the complete image of FIG. 3 is recreated when viewing touchscreen 2 through window 10.

### Third Embodiment

A third embodiment is shown in FIGS. 6a-6c. In this case, the image 12 is animated while being displayed on touchscreen 2. As schematically illustrated in FIG. 6b, the animation can e.g. comprise a periodic enlarging and shrinking of the denomination value 700, even though other types of animations can be used as well, e.g. rotation or color variation as well as, for example, short animated sequences of cartoons or videos.

In contrast to the embodiment of FIG. 4, where animation is used to make image 12 follow any motion of security document 4, in this embodiment animation takes places while document 4 is at rest.

### Fourth Embodiment

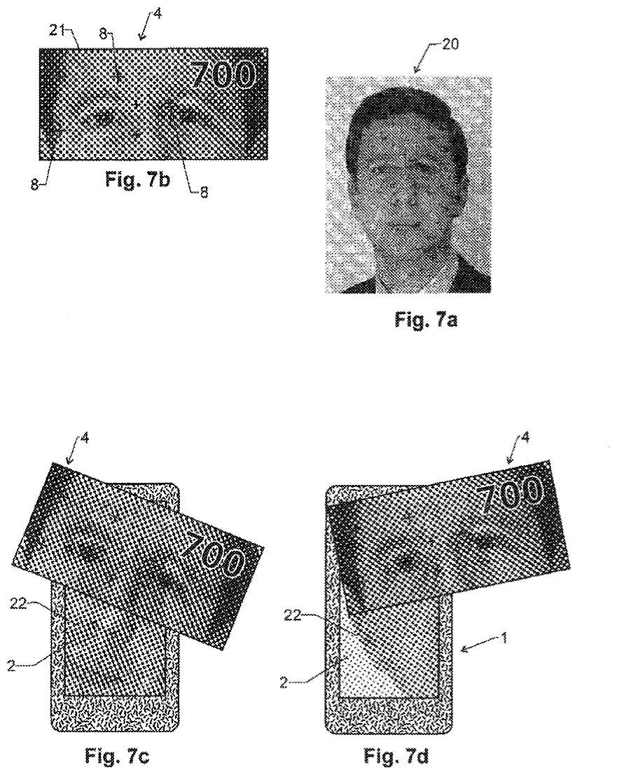

A fourth embodiment is shown in FIGS. 7a-7d. In this case, an “original picture” 20 is provided (FIG. 7a). This picture can e.g. be a photograph, such as a person's face, but it can e.g. also be line art or any other kind of picture that a human observer can verify for integrity.

In a next step, a first part of original picture 20 is printed on security document 4, as shown in FIG. 7b.

To verify security document 4, it is again placed against verification device 1, as shown in FIGS. 7c and 7d. Upon detecting the position and orientation of the document's conductive structure, verification device 1 displays, on touchscreen 2, a second part 22 of original picture 20, orienting and positioning in such that the first and second parts 21, 22 of the picture combine to re-create a larger part of the original picture than first part 21 only.

Advantageously, second part 22 is, in the original picture, adjacent to first part 21, and first part 21 is printed to at least one edge of security document 4, such that a continuous transition between the first and the second parts is formed when security document 4 is placed on verification device 1.

This embodiment can also be combined with a window in the security document, as illustrated with the embodiment of FIGS. 5a-5c. For example, the portrait may be located where the window is and not be printed. In that case, the eye is displayed and it is winking when document placed on the touchscreen.

### Fifth Embodiment

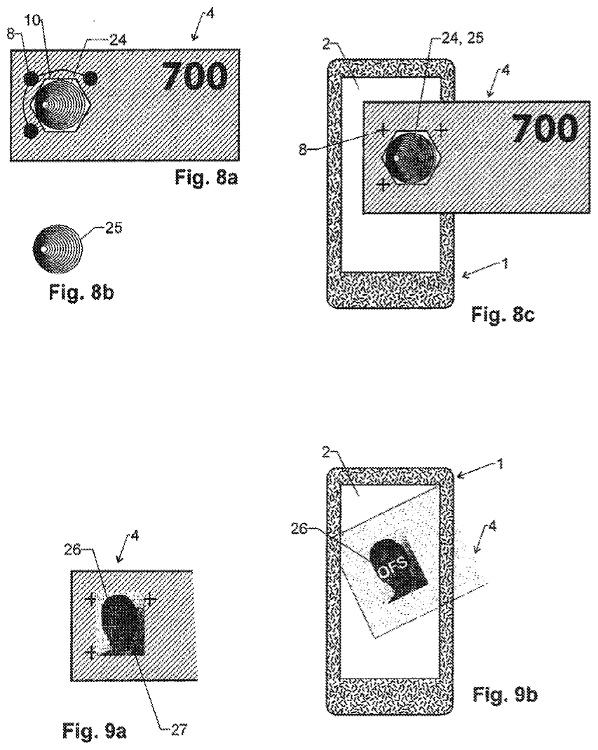

A fifth embodiment is shown in FIGS. 8a-8c. In this embodiment, the interaction region, e.g. window 10, of security document 4, carries a first repetitive pattern 24 or e.g. instead of a window to have a repetitive micro-perforated structure. In this context, a repetitive pattern is a pattern that contains locally repetitive structures, such as the neighboring lines of the circles of the embodiment of FIG. 8a or such as an array of micro-perforated holes.

When security document 4 is placed on verification device 1, a second repetitive pattern 25, as shown in FIG. 8b, is displayed on touchscreen 2. The first and said second repetitive patterns 24, 25 have substantially equal spatial frequency, in the sense as defined above.

The position and orientation of second repetitive pattern 25 are chosen such that the first and second patterns 24, 25 overlap at least in part, thus generating a Moiré effect.

While being displayed, second repetitive pattern 25 can be animated, e.g. by periodically modulating its position, orientation and/or size, in order to generated an animated Moiré effect.

### Sixth Embodiment

The sixth embodiment is shown in FIGS. 9a, 9b. In this embodiment, the interaction region of security document 4 comprises materials having as a property to react under different illumination spectrum such as a fluorescent material 26, e.g. a fluorescent ink and/or metameric inks and/or light transmitting substrate. In the embodiment shown, this ink does not react (e.g. fluoresce) in the absence of short wavelength radiation and e.g. is printed as a series of letters over a portrait 27. The ink may be transparent and/or visible.

When security document 4 is placed on verification device 1, the device calculates the position of the interaction region, i.e. of the fluorescent or metameric material 26, and then causes touchscreen 2 to emit, at least in that region, advantageously in a region larger than the area covered by the fluorescent or metameric material, light having a spectrum selected to generate fluorescence in the fluorescent material and/or to change the color of the metameric material. Typically, this will be light having blue spectral components.

This will cause the fluorescent material 27 to generate visible light, which is easily recognizable to the human observer.

The image emitted by touchscreen 2 can again be animated, e.g. in order to subsequently generate fluorescence in differing parts of fluorescent material 27.

### Seventh embodiment

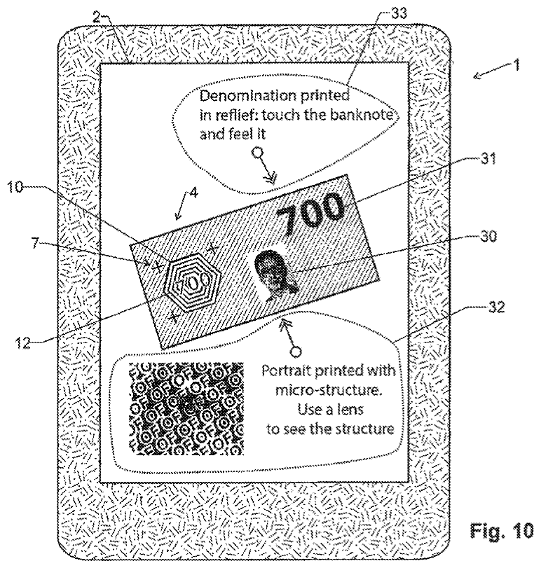

Yet a further embodiment is shown in FIG. 10. This embodiment is preferably carried out on a verification device 1 whose touchscreen 2 is larger than security document 4, e.g. on a tablet device.

In this embodiment, when security document 4 is placed on touchscreen 2, device 1 will cause the touchscreen's sensors to detect, in addition to the document's conductive structure 7, finger gestures indicating that the user is touching document 4. Once such a gesture is detected, its position is combined with the detected position of the conductive structure 7 in order to determine the part of the document that the user has touched.

For example, verification device 1 can determine if the user has touched portrait 30 or the printed denomination 31 of the document in the embodiment of FIG. 10.

Depending on the part of the document that has been touched, security device 1 will then select the image to be displayed on touchscreen 2. (As mentioned, the term image is to be construed broadly and may comprise pictorial information as well as e.g. textual information.)

In the embodiment of FIG. 10, if the user touches no part of security document 4, the image on touchscreen 2 may e.g. only comprise a picture to be displayed in the document's window 10, e.g. the image 12 as shown in FIG. 3 for the first embodiment or comprise a sequence of images or animation describing the document such as the individual features of the banknote or ID document or giving information about the design, the designer or the document issuing company.

If the user touches portrait 30, the image on touchscreen 2 may, in addition, e.g. also comprise information 32 on the portrait, e.g. instructions 32 that explain how to verify the authenticity thereof.

If the user touches the printed denomination 31, the image of touchscreen 2 may, in addition, e.g. also comprise instructions 33 that explain how to verify the authenticity of that part of the document.

This embodiment is easily combined with any of the previous embodiments.

Notes:

In the embodiments above, verification device 1 was a tablet or smartphone designed for general use and loaded with dedicated software to provide support for document verification.

As mentioned, however, verification device 1 may also be a dedicated piece of hardware built for the present purpose.

In another embodiment, verification device 1 can calculate, from the position and location of conductive structure 7, at least one “non-covered region” of touchscreen 2, i.e. a region thereof that is not covered by security document 4, in particular outside an outer contour of security document 4.

In that case, at least part of the image to be displayed by touchscreen 2 is selectively positioned in that non-covered region. This technique can e.g. be used to provide explanations to the user and to make sure that these explanations are not covered by the document. For example, such explanations can e.g. describe the document detected (e.g. “Swiss CHF 700 banknote”). This technique is e.g. exploited by the embodiment of FIG. 10, where the explanations 32, 33 are displayed in regions of touchscreen 2 not covered by document 4.

While there are shown and described presently preferred embodiments of the invention, it is to be distinctly understood that the invention is not limited thereto but may be otherwise variously embodied and practiced within the scope of the following claims.

1. A method for supporting the verification of a security document, wherein said security document comprises at least one electrically conductive structure, comprising the steps of
detecting, by means of a touchscreen of a verification device, a presence, position and orientation of said conductive structure on said touchscreen, and
displaying, on said touchscreen, at least one image whose position and/or orientation depends on the position and orientation of said conductive structure.

2. The method of claim 1, wherein the position and orientation of said image depends on the position and orientation of said conductive structure.

3. The method of claim 1, wherein said security document comprises an interaction region, wherein said method comprises the steps of
calculating, from the position and orientation of said conductive structure, a position and orientation of said interaction region and
adjusting a position and orientation of at least a first region of said image to be located in said interaction region.

4. The method of claim 3, wherein the interaction region of said security document comprises a window, in particular is a window, of said security document.

5. The method of claim 3, wherein said interaction region carries a first repetitive pattern and said first region of said image carries a second repetitive pattern, wherein said first and said second repetitive patterns have substantially equal spatial frequency.

6. The method of claim 3, wherein said interaction region comprises a fluorescent or metameric material and wherein light emitted by said touchscreen in said first region of the image has a spectrum suitable to generate fluorescence in said fluorescent material or to change a color of said metameric material.

7. The method of claim 3, wherein said metal structure extends around at least half of said interaction region.

8. The method of claim 1, comprising the steps of
providing an original picture,
applying a first part of said original picture to said document, and
displaying at least a second part of said original picture as at least part of said image on said touchscreen in such an orientation and position that the first and second parts of the picture combine to re-create a larger part of said original picture than said first part only.

9. The method of claim 1, comprising the step of animating said image.

10. The method of claim 9, wherein said image is animated when said document is at rest against said touchscreen.

11. The method of claim 9 wherein said image is animated to follow said document when said document is moved in respect to said touchscreen.

12. The method of claim 1, comprising the step of
detecting, by means of said touchscreen, a finger gesture indicative of a user touching said document while said document is placed against said touch screen,
determining, from the position and orientation of said conductive structure as well as from the location of said finger gesture, a touched part of the document touched by the user, and
choosing said image or an animation displayed on said touchscreen or a sound played by said verification device as a function of the touched part.

13. The method of claim 1, comprising the steps of
calculating, from the position and orientation of said conductive structure, at least one non-covered region of said touchscreen that is not covered by said security document, and
selectively positioning at least part of said image in said non-covered region.

14. A verification device comprising a control unit and a touchscreen, wherein said verification device is adapted and structured to carry out the method of claim 1.

15. A method for supporting the verification of a security document, wherein said security document comprises at least one electrically conductive structure and a window, comprising the steps of
detecting, by means of a touchscreen of a verification device, a presence, position and orientation of said conductive structure on said touchscreen, and calculating, from the position and orientation of said conductive structure, a position and orientation of said window and
displaying, on said touchscreen, at least one image such that at least a first region of said image is located at said window.

16. The method of claim 15, wherein said window carries a first repetitive pattern and said first region of said image carries a second repetitive pattern, wherein said first and said second repetitive patterns have substantially equal spatial frequency.

17. A method for supporting the verification of a security document, wherein said security document comprises at least one electrically conductive structure and an interaction region, wherein said interaction region comprises at least one of a fluorescent and metameric material, comprising the steps of
detecting, by means of a touchscreen of a verification device, a presence, position and orientation of said conductive structure on said touchscreen, and
calculating, from the position and orientation of said conductive structure, a position and orientation of said interaction region and
displaying, on said touchscreen, at least one image whose position and/or orientation depends on the position and orientation of said conductive structure such that at least a first region of said image to be located in said interaction region,
wherein light emitted by said touchscreen in said first region of the image has a spectrum suitable for at least one of
to generate fluorescence in said fluorescent material and
to change a color of said metameric material.

18. A method for supporting the verification of a security document, wherein said security document comprises at least one electrically conductive structure, comprising the steps of
detecting, by means of a touchscreen of a verification device, a presence, position and orientation of said conductive structure on said touchscreen, and
detecting, by means of said touchscreen, a finger gesture indicative of a user touching said document while said document is placed against said touch screen,
determining, from the position and orientation of said conductive structure as well as from the location of said finger gesture, a touched part of the document touched by the user, and
displaying, on said touchscreen, at least one of an image and an animation, at a position and/or orientation depending on the position and orientation of said conductive structure,
choosing said image or said animation or a sound played by said verification device as a function of the touched part.
